(19) United States
(12) Patent Application Publication
(10) Pub. No.: US 2007/0237359 A1
(43) Pub. Date: Oct. 11, 2007

(54) Method and apparatus for adaptive mean shift tracking

(76) Inventor: Zehang Sun, Reno, NV (US)

Correspondence Address: PILLSBURY WINTHROP SHAW PITTMAN LLP, P.O. BOX 10500, MCLEAN, VA, 22102, US

(21) Appl. No.: 11/398,856

(22) Filed: Apr. 5, 2006

(51) Int. Cl. G06K 9/00

(52) U.S. Cl. 382/103; 382/107

(57) ABSTRACT

The present invention relates to a method and apparatus for adaptive mean shift tracking. In one aspect of the invention, there is provided a method that allows the tracking of an object, with an associated target model, through successive frames of a sequence using a mean shift kernel that has an adjustable scale, and the adjustable scale is automatically updated. In another aspect, the invention the target model is updated as the object continues to move in successive frames. In yet another aspect of the invention, the step of automatically updating further refines the estimate of the new spatial location of the object within the successive frame, and in one particular implementation, the new spatial location is determined by maximizing Bhattacharyya coefficients.

### FIELD OF THE INVENTION

The present invention relates to a method and apparatus for adaptive mean shift tracking.

### BACKGROUND OF THE RELATED ART

Tracking objects in video sequences is very critical in many computer vision applications, for instance, automated video surveillance systems, event inference, driver assistance systems, augmented reality, human machine interface, etc. Two decades of computer vision research have given birth to many powerful object tracking algorithms. Moving object can be tracked in real-time using background subtraction or adaptive background subtraction from stationary cameras. This approach can be also generalized to situations where video data can be easily stabilized, including purely rotating and zooming cameras, and aerial views that allow scene structure to be modeled as an approximately planar surface. Our focus here, however, is on object tracking algorithms without any prior knowledge of scene structure or camera motion.

Tacking methods can be classified into various sets of categories according to different criteria. As far as statistical models are concerned, tracking methods may be classified into Bayesian tracking (including Kalman filters, Extended Kalman filters, Particle filters, Unscented particle filters, etc.) and non-Bayesian tracking (SSD, Mean-shift, etc.). In the Bayesian framework, tracking is modeled as a dynamic state estimation problem, and one attempts to construct the posterior probability density function of the state based on all available information, including the set of received measurements. Because the pdf contains all the information we need, it is considered to be the complete solution to the estimation problem. Kalman filtering is the simplest state estimation method based on Gaussian distribution assumption. Unfortunately, it is restricted to situation where the probability distribution of the state parameters is unimodal and state function is linear. Although Extended Kalman Filter (EKF) was designed for non-linear and non-Gaussian situation, its local linearization and Gaussian approximation are not a sufficient description of the non-linear and non-Gaussian nature of some applications. Once the EKF cannot adequately approximate the multi-modal nature of the underlying posterior, the Gaussian approximation fails—the EKF is prone to either choosing the “wrong” mode or just sitting on the average between the modes. Recently algorithms using sequential Monte Carlo simulation emerge as a better method to handle non-linearity and non-Gaussianity. In the literature, the sequential Monte Carlo approach is known variously as bootstrap filtering, the condensation algorithm, particle filtering, interacting particle approximation, survival of fittest, etc.

Particle filters are sequential Monte Carol methods based upon point mass representations of probability densities, a generalization of the traditional Kalman filter method. Success of the particle filter algorithm depends on the validity of the following underlying assumptions: Monte Carlo assumption: The point-mass approximation provides an adequate representation of the posterior distribution. Importance sampling assumption: it is possible to obtain samples from the posterior by sampling from a suitable proposal distribution and applying importance sampling corrections. If any of these two conditions are not met, any particle filter based algorithm can perform poorly.

The discreteness of the approximation poses a resolution problem. In the re-sampling stage, any particular sample with high importance weight will be duplicated many times. As a result, the cloud of samples may eventually collapse to a single sample. This degeneracy will limit the ability of the algorithm to search for lower minima in other regions of the error surface. In other words, the number of samples used to describe the posterior density function will become too small and inadequate. A brute force strategy to overcome this problem is to increase the number of particles. A more refined strategy is to implement a Markov chain Monte Carlo step after the selection step. The Mean-shift algorithm is a nonparametric statistical method for seeking the nearest mode of a point sample distribution. This algorithm has been adapted to appearance-based blob tracking. Mean-shift tracking algorithm is an every efficient method, capable of tracking non-rigid objects without any prior knowledge of scene structure or camera motion. Many successful applications have been seen in the literature. As two of the test sequences, mean-shift has been used to track football players and people on subway platforms, demonstrating its capability of handling non-rigid objects undergoing rugged, as well as smooth movements. A master-slave system has been developed to acquire biometric imagery of human at distance, where mean-shift was utilized to track detected peoples. Mean-shift has also been employed for target tracking in Forward Looking Infrared (FLIR) images taken from an airborne platform, where both the intensity and local standard deviation distribution are exploited.

If the number of views is considered, there are single-view tracking, multiple-view tracking, and omni-directional-view tacking. Tracking can also be classified according to other criteria such as the dimension of tracking space (2-D vs. 3-D), cameras' state (moving camera vs. stationary), process orders (bottom-up vs. top-down) etc.

Scale/bandwidth is a critical parameter in the mean-shift procedure. If the scale is bigger than the size of the tracked object, undesirable background pixels will dilute the target candidate pdf. On the other hand, if the scale is too small, the tracked window might roam around, introducing lots of noise to the trajectory of the center of tracking. Unfortunately, mean-shift procedure has no built-in scale adaptation mechanism.

Two scale selection methods previously proposed do not work well. The first was a non-parametric method based on normalized density gradient, and this method assumes no formal structures on the data being processed. The second method imposed a local structure on the data and assumes that locally the density is symmetric normal. Both of these two methods, however, are too computationally expensive for real-time tracking application.

Under the tracking context, a “plus and minus 10 percent” method was investigated, where the mean-shift was repeated three times, using window size of plus or minus 10 percent of the current size as well as the size in the previous frame, to find the best in terms of Bhattacharyya coefficient. This “plus and minus 10 percent” strategy does keep the window from growing too large, but it does not keep the windows from shrinking too small as the observations made. Just on the opposite, scale updating using the “plus and minus 10 percent” strategy leads to rapid scale expansion.

Feature scale selection theory has also been combined with canonical mean-shift algorithm, enabling tracking of a blob that changes in scale space. To be specific, two interleaved mean-shift procedures have been employed: one representing the spatial location and the other the scale of the target. This algorithm works on the image filtered by Difference-Of-Gaussian (DOG) filters, instead of raw image in the canonical mean-shift.

### SUMMARY OF THE INVENTION

The present invention relates to a method and apparatus for adaptive mean shift tracking.

In one aspect of the invention, there is provided a method that allows the tracking of an object, with an associated target model, through successive frames of a sequence using a mean shift kernel that has an adjustable scale, and the adjustable scale is automatically updated.

In another aspect, the invention the target model is updated as the object continues to move in successive frames.

In yet another aspect of the invention, the step of automatically updating further refines the estimate of the new spatial location of the object within the successive frame, and in one particular implementation, the new spatial location is determined by maximizing Bhattacharyya coefficients.

### BRIEF DESCRIPTION OF THE DRAWINGS

FIG. 1 illustrates a block diagram of the mean shift tracking apparatus according to the present invention;

FIG. 2 illustrates a block diagram of a preferred embodiment of the mean shift tracking method according to the present invention;

FIG. 3, rows 1 and 2; columns 1, 2, 3, and 4 illustrate a head tracking sequence using prior art methods and row 3; columns 1, 2, 3, and 4 a method according to the present invention.

FIG. 4, rows 1 and 2; columns 1, 2, 3, and 4 illustrate an object tracking sequence using prior art methods and row 3; columns 1, 2, 3, and 4 a method according to the present invention.

FIG. 5, row 1; columns 1, 2, 3, and 4 illustrates another head tracking sequence using prior art methods and row 2; columns 1, 2, 3, and 4 a method according to the present invention.

### DETAILED DESCRIPTION OF THE PREFERRED EMBODIMENTS

1. Introduction

The present invention describes, in one embodiment, advantageous methods and apparatus for object tracking in which mean-shift iteration procedure is integrated with statistical modeling. The method and apparatus described, preferably used along with a sequential Monte Carlo simulation scheme and a dynamic probabilistic model, is capable of tracking objects in clustered background with size changing.

The preferred sequential Monte Carlo simulation based method has been investigated toward automatic scale update for mean-shift based tracking. Specifically, we model the scale updating in the framework of MAP estimation, and evaluate the posterior probability using Sequential Importance Sampling (SIS) method. Besides scale, target model needs to be updated during the course of tracking too. As described, a statistical model has been fitted to the distance measurements derived from Bhattacharyya coefficients to automate the adaptive target model evolution.

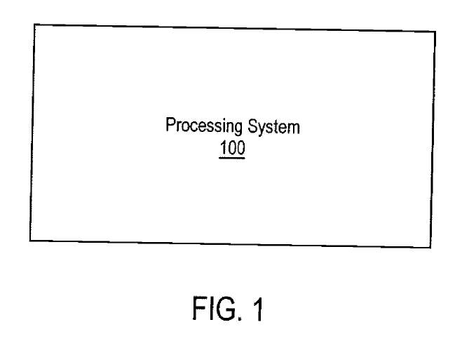

FIG. 1 illustrates a block diagram of the mean shift tracking apparatus according to the present invention as including a processing system 100, which can be a stand alone or distributed computing system, which contains a processor, memory, and will execute a program, in either hardware, software, or a combination thereof, that implements the features of the present invention described herein.

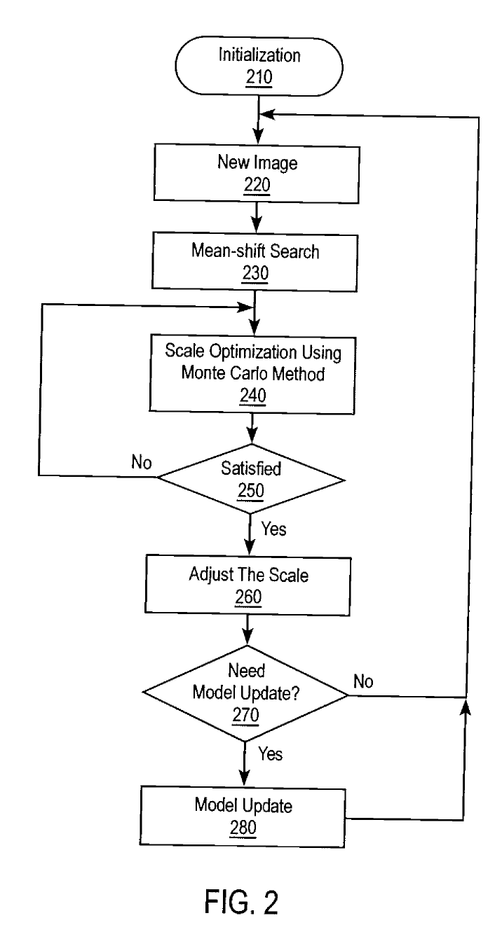

FIG. 2 illustrates a block diagram of a preferred embodiment of the mean shift tracking method 200 according to the present invention with details as further described herein.

In the initial step 210, an initial location and the object to be tracked is specified, which can be done with an object detection algorithm or simply specified manually. Besides the initial location, parameters and other thresholds for the scale optimization and model update are set in the Initialization step 210. These parameters and thresholds are known in the art for instance, the criteria for updating the model is p<uk-2*sigma, where 2 is a threshold, and one of ordinary skill will understand that this threshold could be changed to 3 if the model update can occur less often and still produce good results for the particular application. Similarly, for the Monte Carlo process, if the background is very clear and size of the object changes very slowly, the number of samples could be less.

After the initialization step 210, the present invention tracks the object through successive new images/frames, with the first new image obtained at step 220, and, as described hereinafter, for each subsequent new image. For any new image, a mean-shift search is performed as shown in step 230. The preferred mean-shift search is discussed in Section 2 “brief review of Mean-shift algorithm” hereinafter.

The output of the mean-shift search result from step 230 is the starting point of the iterative scale optimization step 240. Scale optimization step 240 continues until it reaches a threshold (preferably predefined), as described in Section 3 hereinafter, which threshold is indicated as being obtained by the step 250 labeled “satisfied,” such that if the threshold is not obtained, another iteration of scale optimization in step 240 continues, whereas if the threshold is obtained, then scale adjustment step 260 follows and the scale is adjusted accordingly.

After adjusting the scale in step 260, a model update decision step 270 occurs to determine whether or not to update the model based on the predefined threshold, as is further described hereinafter in Section 4. If the model needs to be updated, then it is updated in step 280, as further described in Section 4, otherwise the process continues with a next image in the successive frames being obtained in step 220, and the process repeating.

The following descriptions are provided regarding the various steps set forth above.

2. Brief Review of Mean-Shift Algorithm

Mean-shift is an iterative process that in its most standard form is equivalent to a clustering methodology. That is, a group of neighboring points in a Euclidean space is represent by a single point located at the neighborhood's average. Mean-shift is considered a generalization of the popular k-means algorithms. Recently, there has been a deployment of the mean-shift algorithm for tracking objects based on some features, including color content, gradient of the pixel intensity, etc. Mean-shift tracking is robust in the presence of partial occlusions and changes in camera position.

2.1 Mean Shift Algorithm

Tracking using the mean-shift algorithm begins by building an appearance model, referred to as target model hereafter. An initial estimate of the position of the object must also be provided. Tracking of the object is then reduced to finding the trajectory produced by applying the mean-shift procedure starting from an initial point representing the position of the object in the current image. Convergence of the mean-shift algorithm on each frame is determined by a matching criterion between the color histogram distribution of target model and that of a target candidate.

2.1.1 The Color Histogram Distribution of the Target Model

The initial object localization can be done either automatically or manually. In the current phase of this work, we draw a rectangle around the object manually. Once the object of interest has been localized, the RGB probability distribution of the target model is formed as the 3D color histogram of the weighted RGB values of pixels contained in the rectangle of size(h{x},h{y}) centered at the target model's center. Denoting bar {x}{j} as the relative coordinates of the target model's pixels in the rectangle, with respect to its center. The model's distribution is approximated by using m bins per color channel for computational reasons. Pixel color intensities are weighted using Epachelnikov profile of radius r defined as following:

$${k}_{E} ( x ) = \{ \begin{matrix}\frac{2}{π {r}^{2}} ( 1 - x ) & if x < 1 \\ 0 & otherwise\end{matrix}$$

The color histogram of distribution of the target model is given by:

$${θ}_{s} = \frac{{\sum }_{j = 1}^{n} {k}_{E} ( {‖ {\tilde{x}}_{j} ‖}^{2} ) δ [ λ ( {\tilde{x}}_{j} ) - s ]}{{\sum }_{j = 1}^{n} {k}_{E} ( {‖ {\tilde{x}}_{j} ‖}^{2} )}$$

where n is the number of pixels inside the rectangle, and lambda(cdot) is function that maps the pixel at location bar{x}{j } to the index lambda(bar{x}{x}) of the color histogram. delta(cdot)is the Dirac function. It is not hard to prove that Sigmaˆ{m} {s=1}theta{s}=1.

2.1.2 The Color Histogram Distribution of the Target Candidate

Assuming that y is the center of the new target location, the color histogram distribution of the target candidate phi {s}(y) can be formulated in a similar fashion as following:

$${ϕ}_{s} ( y ) = \frac{{\sum }_{j = 1}^{{n}^{*}} {k}_{E} ( {‖ \frac{y - {x}_{j}}{h} ‖}^{2} ) δ [ λ ( {\tilde{x}}_{j} ) - s ]}{{\sum }_{j = 1}^{{n}^{*}} {k}_{E} ( {‖ \frac{y - {x}_{j}}{h} ‖}^{2} )}$$

It is worth mentioning that the number of pixel n{*} might be different from that in Equation 2, because the size of the object might undergo some changes.

Trust-region method is more powerful than the mean-shift line search based.

2.1.3 Color Histogram Matching Maximization

Given the representations of the target model and target candidate color distributions, object tracking using mean-shift has been treated as an optimization problem—minimizing a distance measure between the model and candidate histograms. Specifically, the image location $y_{next}$ that maximizes the Bhattacharyya coefficients $r\ho(y_{next})$ is the estimate of the new location. The Bhattacharyya coefficient is defined as:

$$ρ ( {y}_{next} ) ≡ ρ ( ϕ ( {y}_{next} ) , θ ) = arg {max}_{y} \sqrt{ϕ ( y ) θ}$$

It is clear from the definition that Bhattacharyya coefficient is a location-dependent quantity, resembling correlation. After some mathematical manipulations, the Bhattacharyya coefficient can be further approximated by:

$$ρ ( ϕ ( {y}_{next} ) , θ ) \approx \frac{1}{2} {\sum }_{s = 1}^{m} \sqrt{{ϕ}_{s} ( {y}_{curr} ) {θ}_{s}} + \frac{C}{2} {\sum }_{j = 1}^{{n}^{*}} {w}_{j} {K}_{E} ( {‖ \frac{y - {x}_{j}}{h} ‖}^{2} )$$

where the coefficient C are given by:

$$C = \frac{1}{{\sum }_{j = 1}^{{n}^{*}} {k}_{E} ( {‖ \frac{y - {x}_{j}}{h} ‖}^{2} )}$$

and the weights w {j} is defined as:

$${w}_{j} = {\sum }_{s = 1}^{m} δ [ λ ( {x}_{j} ) - s ] \sqrt{\frac{{θ}_{s}}{{ϕ}_{s} ( y )}}$$

To maximize the Bhattacharyya coefficient in Eq. 4, we need to maximize the second term in Eq. 5, which can be found employing the mean-shift procedure. In this procedure, the kernel is recursively moved from the current location y{n} to the new location y{n+1}, according to the relation:

$${y}_{n + 1} = \frac{{\sum }_{j = 1}^{{n}^{*}} {x}_{j} {w}_{j} {k}_{E} ( {‖ \frac{{y}_{n} - {x}_{j}}{h} ‖}^{2} )}{{\sum }_{j = 1}^{{n}^{*}} {w}_{j} {k}_{E} ( {‖ \frac{{y}_{n} - {x}_{j}}{h} ‖}^{2} )}$$

2.2 Implementation Considerations

One implementation consideration of the described mean-shift based tracking is that at least some part of the target in the next frame should reside inside the kernel, i.e. it cannot handle big movement. The mean-shift search will lead the function to a local instead of global maximum. The search path might be distracted by other local maximum if the optimal mode is far away. Consequently, the success of the mean-shift tracking algorithm is based an implicit assumption—image location of the object being tracked does not change dramatically from frame to frame. We can also see this hidden requirement mathematically. Recall that Taylor series expansion around the current location y{curr} has been carried out to get Eq. 5, which is, once again, based upon the small movement assumption, because Taylor series expansion is valid only for y locating in the very close neighborhood of y{curr}.

According to the algorithm described above, for a given target model, the location of the target in the current frame minimizes the distance in the neighborhood of the previous location estimate. The scale of the target often changes in time, and thus the bandwidth of the kernel profile have to be adaptive accordingly. If the kernel size is chosen too small, it might roam around on a plateau close to the true mode, leading to poor target localization. If the mean-shift algorithm outputs are used to direct a P/T/Z camera, this “roaming” scenario is particularly bad, because the P/T/Z camera will jump randomly. On the other hand, if the target kernel size is too large, the tracked windows will include many background pixels. It will distract the tracker from the target object. There is no natural mechanism within the mean-shift framework for choosing or adapting kernel size over time.

3. Scale Selection

The present invention solves the scale updating in the framework of Bayesian tracking by modeling the scale using a dynamic model contaminated by random noise. SIS method has been utilized to approximated the posterior probability, as described below.

3.1 Bayesian Tracking

The present invention models the tracked object simply as arbitrarily sized rectangles, though other shapes could be used as well. Let {X} denote the state space of all such rectangles. The task of scale update is to select an element from {X} at time t. To be more concrete, in the Bayesian framework, one wishes to estimate probability density function on the state space. Once this density has been found, a number of estimators can be applied in order to recover the single state which reflects the actual object size the best.

To define this problem, consider the evolution of the state sequence {X}={x}{t}, t\in \mathcal{N}} of a target, given by the dynamic model:
xₜ=fₜ(xₜ₋₁, vₜ₋₁)
where f{t} is a non-linear function of the state {x}{t−1}, and {v}{t−1}} is an element sequence. The objective of the scale updating is to continuously estimate {x}{t} from the all available measurements up to time t:
Zₜ={z₁, z₂, . . . , zₜ₋₁, zₜ}
and we have the measurement model:
zₜ=hₖ(xₜ, nₜ)
where h{t} is a non-linear function of the state {x}{t}, and {{n}{t}} is an element of a noise sequence.

From a Bayesian perspective, the scale updating problem is to recursively calculate some degree of belief in the state {x}{t} at time t, taking different values, given all the observations {Z}. Thus, it is required to construct the pdf of p({x}{t}|{Z}{t}). We can assume that the initial pdf p({x}{0}|{Z}{0}) \equiv p({x}{0}) is available. Then, theoretically, the pdf p({x}{t}|{Z}{t}) may be obtained recursively in two stages: prediction and update.

If the pdf p({x}{t−1}|{Z}{t−1}) at time t−1 is available, we can obtain the following prior pdf of the state at time t via the Chapman-Kolmogorov equation:
p(xₖ|Zₜ₋₁)=∫p(xₜ|xₜ₋₁)p(xₜ₋₁|Zₜ₋₁)dxₜ₋₁₎

The probabilistic model of the state evolution p({x}{t}|{x}{t−1}) is defined by the system Eq. 9.

At time step t, a measurement {z}{k} becomes available, and this can be used to update the prior via Bayes' rule:

$$p ( {x}_{t} \vert {Z}_{t} ) = \frac{p ( {z}_{t} \vert {x}_{t} ) p ( {x}_{t} \vert {Z}_{t - 1} )}{p ( {z}_{t} \vert {Z}_{t - 1} )}$$

where the denominator is a constant depending on the measurement model (Eq. 11) and can be computed by:
p(zₜ|Zₜ₋₁)=∫p(zₜ|xₖ)p(xₜ|Zₜ₋₁)dxₜ

In the update state, as shown in Eq. 13, the new measurement {z}{t} is used to modify the prior density to obtain the posterior density of the current state. This recursive propagation of the posterior density, however, is only a conceptual solution in general—it cannot be computed analytically \cite{Eveland01}\cite{Arulampalam02}. In this invention, we preferably use the Sequential Importance Sampling (SIS) algorithm.

3.2 Problem Formulation Using SIS

SIS is a Monte Carlo method that forms the basis for most sequential Monte Carlo filtered developed in over the past decades. This technique is for implementing a recursive Bayesian filter by Monte Carlo simulations. The key idea is to represent the required posterior density function by a set of random samples with associated weights and to compute estimates based on these samples and weights. As the number of samples become very large, this Monte Carlo quantity becomes an equivalent to the posterior pdf, and SIS filter approaches the optimal of the Bayesian estimate. In the literature, the sequential Monte Carlo approach is known variously as bootstrap filtering, the CONDENSATION algorithm, particle filtering, interacting particle approximation, survival of fittest, etc.

Denoting {x}{t}{i},w{t}{i}} a set of random measures characterizing the posterior pdf p({x}{t}|{Z}{t}), the posterior density at time t can be approximated by:

$$p ( {x}_{t} \vert {Z}_{t} ) \approx {\sum }_{i = 1}^{N} {ω}_{t}^{i} δ ( {x}_{t} - {x}_{t}^{i} )$$

where {x}{k}{i},i=0, . . . N} is set of support points with associated weights {w{k}ˆ{i},i=0, . . . N\}, and we have:

$${\sum }_{i}^{N} {w}_{t}^{i} = 1$$

The weights are preferably chosen using the Importance Sampling. At each iteration, one could have samples constituting an approximation to p({x}{t−1}|{Z}{t−1}), and want to approximate the p({x}{t}|{Z}{t}) with a new set of samples. The modified weight is then can be computed as:

$${w}_{k}^{i} ∝ {w}_{t - 1}^{i} \frac{p ( {z}_{t} \vert {x}_{t}^{i} ) p ( {x}_{t}^{i} \vert {x}_{t - 1}^{i} )}{q ( {x}_{t}^{i} \vert {x}_{t - 1}^{i} , {z}_{t} )}$$

and the posterior density p({x}{t}|{Z}{t}) can be approximated as:

$$p ( {x}_{t} \vert {Z}_{t} ) \approx {\sum }_{i = 1}^{N} {w}_{t}^{i} δ ( {x}_{t} - {x}_{t}^{i} )$$

where q({x}{t}ˆ{i}|f{x}{t−1}ˆ{i},f{z}{t}) in Eq. 17 is the importance density. The importance density is an auxiliary distribution which is proportional to p(cdot) and easier to be evaluated. Choosing a good importance density is very essential in evaluating Eq. 17, and not carefully chosen one will lead to the evaluation intractable. It is often convenient to choose the importance density to be the prior,
q(xₜⁱ|xₜ₋₁ⁱ,zₜ)=p(xₜⁱ|xₜ₋₁ⁱ)
Substitution of Eq. 19 into Eq. 17 yields:
wₖⁱ∝wₜ₋₁ⁱp(zₜⁱ|xₜⁱ)

To evaluate p({z}{t}|{x}{t}ˆ{i}) in Eq. 20, where {z}{t} is an observation and f{x}{i} is a set of parameters, we propose to use the normalized Bhattacharyya coefficient as following:

$$p ( {z}_{t} \vert {x}_{t}^{i} ) = \frac{ρ ( {x}_{i} )}{{\sum }_{i = 1}^{N} ρ ( {x}_{i} )}$$

The pseudo-code description of the proposed scale selection method using SIS is summarized as following, given {{x}{t−1}ˆ{i}, w{t−1}ˆ{i}}, for i=1, 2, . . . N:

Draw {x}{i} following the importance density p({x}|{x}{t−1}) for i=1, 2, . . . N.

Assign a new weight, w{t}ˆ{i}, according to Eq. 20.

A common problem with the SIS is the degeneracy phenomenon, where after a few iterations, all but one support points will have negligible weight. In our work we use the resampling method to eliminate this problem.

Once we know the posterior pdf p({x}{t}|{Z}{t}), we can solve the scale selection problem using the MAP estimator.

4. Target Model Update

Due to the scale invariance property of the Bhattacharyya coefficient defined in Eq. 5, it is possible that the size of the target model and size of the target candidate are different. The above section provides a solution for target candidate scale evolution, we still, however, need a mechanism for updating the target model. It is obvious that we should not update the target model every time we update the target candidate scale, because adaptively updating appearance models in this manner raises the specter of model drift, a classic problem in adaptive tracking. Model drift builds up gradually over time as misclassified background pixels start to “pollute” the foreground model, leading to further misclassification and eventual tracking failure. A straight forward solution is to change the target model using a constant threshold on the similarity metric used in tracking. The basic problem here is to select right value for all the sequences, i.e. a particular threshold may work very well for one sequence, but it may fail for others.

If we want to update the target model automatically, some sequence-dependent information has to be employed. In this invention, we preferably use the information reflecting the rate of change of the target candidates, which is derived from the Bhattacharyya coefficient defined in Eq. 5. To formulate the sequence-dependent measure over time, we model the distribution of the Bhattacharyya coefficient as a single Gaussian. The distribution parameters of the Gaussian, mean u and standard deviation $sigma$, are updated at each frame using:

$${μ}_{t} = \frac{( t - 1 ) {μ}_{t - 1} + {ρ}_{t}}{t}$$

$$and$$

$${σ}^{2} = \frac{( t - 2 ) {σ}_{t - 1}^{2}}{t - 1} + \frac{{( {ρ}_{t} - {μ}_{t - 1} )}^{2}}{t}$$

Computing the parameters in this iterative fashion can save lots of resources both computation wise and memory wise. The decision whether to update the model is made based on the current value of the coefficient $rho{t}, i.e. if $rho{t}<mu{k}−2\sigma{t} then the target mode will be updated.

5. Experimental Results

The described invention has been tested using many different video sequences filmed under different environments. In one set of tests, the sampling frequency for the video clip was 20 Hz. The RGB color space was utilized as feature space and quantized into 24×24×24 bins. We have experience with different numbers of bins close to 24, no noticeable differences have been observed. Each of the targets was initialized with a rectangle in the first frame of the sequence, and tracked automatically throughout the rest of the sequence.

For comparison purposes, the fixed scale mean-shift based tracking method, as well as the plus-minus-10-percent based scale update mean-shift method has also been implemented. We apply those two methods onto the same sequences with identical initializations and the experimental results are reported in the following. The head tracking sequence one has 1129 frames, i.e. a 56 seconds video clip. The whole sequence consists of zooming in and out on a person sitting on his chair, plus some camera movements, as well as small object movements including turning his head, lean back to chair, etc. The fixed scale method was applied onto this sequence first, see FIG. 3. The subject was tracked successfully throughout the whole sequence, and the frames No. 10, 289, 728, and 1610 were shown on the first row in FIG. 3. The localization, however, was very poor due to the fixed scale, for instance, the tracked region in frame No. 1610 is about 9 times bigger than the actual subject size. In addition, the tracking windows roam around when the camera was zoomed in onto the subject. The images on the second row in FIG. 3 shows the tracking results using the plus-minus-10-percent scheme. Following this scheme, at each iteration, the mean shift algorithm run three times using three different window sizes—the current window size, window size plus 10 percent of the current size and window size minus 10 percent of the current size. The window size yielding the biggest Bhattacharyya coefficient will be kept as the current scale. The results shows that the windows expanded too much quickly. The tracking results using the proposed algorithm are on the third row in FIG. 3. The subject was tracked successfully throughout the sequence and the localizations were quite accurate.

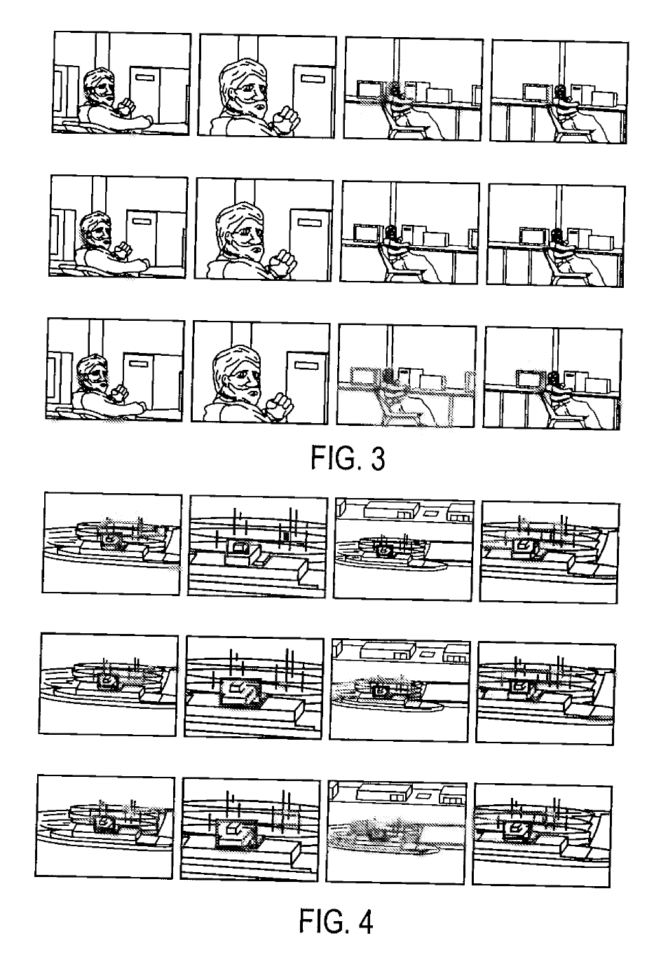

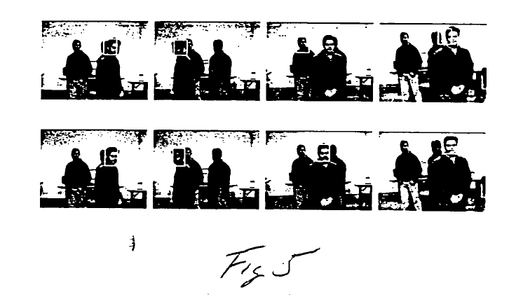

A second test sequence is a 104 second video clip (2079 frames), similar to the first one, the camera was zoomed in and out a lot during the course of filming, see FIG. 4. Following the same testing strategy, we applied fixed scale algorithm (first row in FIG. 4, plus-minus-10-percent method (second row in FIG. 4), as well as the proposed algorithm (third row in FIG. 4) into this sequence. Similar observations can be made from the tracking results: fixed scale method has poor localizations, plus-minus-10-percent scheme loses target quickly, and the proposed method produces the best results.

To get an idea about the robustness of the method of the invention, testing it on a sequence with cluttered and deceivable background was helpful. The sequence contained three persons, and one walking in front of the other two five times. It is a 32 second clip with 640 frames. Due to the poor performance of the plus-minus-10-percent scheme, we excluded it from our discussion—only the results from fixed scale method and our algorithm were included. It is worth mentioning that the fixed scale method lost the tracking window to the background person during the third time passing, see images on the first row of FIG. 5, and picked the window up during the last time. The proposed method tracked the target tightly and throughout, see second row of FIG. 5.

In summary, described herein is a robust approach for tracking objects in video sequences. Armed with mean-shift procedure and a sequential importance sampling scheme, this method is capable of adjusting the kernel size automatically during the course of tracking, which distinguishes its from other mean-shift based tracking algorithms.

In the preferred embodiment, the adaptation in our method includes two aspects, one is the size of the target candidate, the other is the target model evolution. We model the sizes of target candidates as time series governed by a dynamic model and contaminated by some random noises. A Monte Carlo simulation procedure using SIS is applied onto the time series to approximate the posterior probability density function of the parameters given all the observations. To find the best set of parameters, a MAP estimator is employed. During the course of tracking, target appearances will keep changing, consequently, target model needs to by updated. A distance metric based on Bhattacharyya coefficients is described as the indicator for model update herein.

Although mean shift can be applied to different primitives, the canonical mean shift based tracking algorithm utilizes intensity and color information. The Bhattacharyya coefficients based distance measure considers only the pdf of the intensity/color information. The shape information, however, is more critical in either object detection or tracking. Integrating shape information with intensity information seamlessly should be able to yield better results than intensity information alone.

What is claimed is:

1. A method of determining movement of an object within a video sequence comprising:
identifying an object for tracking within an initial frame of the video sequence;
obtaining at least one image of the object;
determining, using the at least one image of the object, a target model of the object;
associating a mean-shift kernel having an adjustable scale with the target model;
with a successive frame of the video sequence:
using a mean-shift search to estimate a new spatial location of the object within the successive frame and provide a location signal based thereon; and
automatically updating the adjustable scale of the mean-shift kernel based upon the location signal using a Monte Carlo process, thereby attempting to ensure that the mean-shift kernel remains properly sized.

2. The method according to claim 1 further including the step of, with the successive frame of the video sequence, updating the target model.

3. The method according to claim 1, wherein the steps of, using the mean shift search and automatically updating are repeated as the object continues to move.

4. The method according to claim 3 further including the step of, with successive frames of the video sequence, updating the target model in a repeated manner as the object continues to move in successive frames, and wherein the target model is updated less frequently than the automatic updating of the scale of the mean-shift kernel.

5. The method according to claim 1 wherein the step of obtaining images of the object obtains the images from a camera.

6. The method according to claim 1 wherein the step of automatically updating further refines the estimate of the new spatial location of the object within the successive frame.

7. The method according to claim 1 wherein the kernel has a rectangular size.

8. The method according to claim 1 wherein the new spatial location is determined by maximizing Bhattacharyya coefficients.

9. The method according to claim 1, further including the step of determining that the object is lost.

10. The method according to claim 1 wherein the step of determining the target model obtains a three dimensional RGB probability distribution for the target model.

11. The method according to claim 10 wherein the three dimensional RGB probability distribution is one of color content and gradient of pixel intensity.

12. An apparatus for determining movement of an object within a video sequence comprising:
means for identifying an object for tracking within an initial frame of the video sequence;
means for obtaining at least one image of the object;
means for determining, using the at least one image of the object, a target model of the object;
means for associating a mean-shift kernel having an adjustable scale with the target model;
means for using a mean-shift search to estimate a new spatial location of the object within the successive frame and provide a location signal based thereon; and
means for automatically updating the adjustable scale of the mean-shift kernel based upon the location signal using a Monte Carlo process, thereby attempting to ensure that the mean-shift kernel remains properly sized.
